(19) United States
(12) Patent Application Publication
(10) Pub. No.: US 2016/0003448 A1
(43) Pub. Date: Jan. 7, 2016

(54) COLOR FILTER LAYER, COLOR FILM SUBSTRATE AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Ming DONG, Beijing (CN); Hongjiang WU, Beijing (CN); He FENG, Beijing (CN); Yu XIAO, Beijing (CN); Jing YUAN, Beijing (CN)

(21) Appl. No.: 14/381,323

(22) PCT Filed: Dec. 6, 2013
(86) PCT No.: PCT/CN2013/088754

§ 371 Date: Aug. 27, 2014

(30) Foreign Application Priority Data
Aug. 21, 2013 (CN) 201310367354.5

(51) Int. Cl. F21V 9/16; G02B 5/22

(52) U.S. Cl. CPC F21V 9/16; G02B 5/22; Y10S 977/774; B82Y 20/00

(57) ABSTRACT

A color filter layer, a color film substrate including the color filter layer, and a display apparatus including the color filter substrate are provided. The invention relates to the field of display technology and can solve the problem that the color membrane substrates in the prior art have a relatively low utilization ratio of light. The color filter layer of the invention comprises a filter membrane and a light conversion layer disposed on the light entering side of the filter membrane. According to the invention, the light of other frequencies in incident light can be converted into light having the same spectral characteristics as the respective filter membranes, due to the presence of the light conversion layer. Therefore, the utilization ratio of light and the display brightness can be improved, and thus energy consumption can be saved effectively and the display performance can be enhanced.

### FIELD OF THE INVENTION

The present invention relates to the field of display technology. More particularly, the present invention relates to a color filter layer, a color film substrate comprising the color filter layer, and a display apparatus comprising the color film substrate.

### BACKGROUND OF THE INVENTION

In a display apparatus, incident light can be filtered effectively by a color film so as to achieve the aim of color display. However, light loss occurs when incident mixed-color light passes through the three filter membranes (such as R, G, and B) of a color film substrate. For example, only red light can be transmitted through the red filter membrane, while the light of other colors is blocked. As such, the incident light attenuates significantly and much thereof is wasted. Therefore, how to effectively use the incident light has attracted a lot of interest in the research field of display technologies.

A quantum dot, also known as a nanocrystal, is a semi-conductor nanostructure of which the excitons are confined in all three spatial dimensions. A quantum dot is typically composed of a semi-conductor material, such as CdS, CdSe, CdTe, ZnSe, InP, InAs, or the like, or it is composed of two or more kinds of semi-conductor materials, such as CdSe doped with ZnS, CdSe doped with ZnSe, or the like. Common quantum dots are nanoparticles composed of compounds having II-VI or III-V elements. Typically, quantum dots have a particle size between 1 nm and 10 nm. As continuous energy band turns into discrete energy levels due to electrons and holes being confined in a quantum, fluorescence occurs when it is excited. The spectrum of light emitted by a quantum dot can be controlled by adjusting its size. A spectrum spanning the entire visible light region may be realized by adjusting the size and components of quantum dots.

Up-conversion luminescence, also known as frequency up-conversion luminescence, is a process in which radiative transition occurs at a higher energy level by virtue of the sequential absorption of photons. In such a process, the radiation energy of a photon is more than the pumping energy thereof. That is to say, in up-conversion luminescence, light having a wavelength shorter than that of excitation light can be emitted continuously upon excitation by the light having a long wavelength. An up-conversion material is a material which can realize the up-conversion luminescence, and such material is typically doped with rare earth ions.

### SUMMARY OF THE INVENTION

An object of the present invention is to provide a color filter layer having a high utilization ratio of light, in order to solve the problem that the color filter layers in the prior art have a relatively low utilization ratio of light.

This object is achieved by a color filter layer comprising a filter membrane and a light conversion layer disposed on the light entering side of the filter membrane.

Herein, the term “light conversion layer” refers to a layer by which at least a portion of incident light can be converted into light having the same spectral characteristics as a filter membrane.

With a suitable light conversion layer, the light of other frequencies in incident light can be converted into light having the same spectral characteristics as the respective filter membrane, so as to enhance the utilization ratio of light and improve display brightness, and thus to save energy effectively and improve the display performance.

Preferably, the light conversion layer comprises a quantum dot and/or an up-conversion material.

More preferably, the quantum dot is made from at least one of CdTe, CdSe doped with ZnS, and CdSe doped with ZnSe.

Preferably, the filter membrane includes a blue filter membrane, and the light conversion layer disposed on the light entering side of the blue filter membrane comprises an up-conversion material.

More preferably, the up-conversion material is made from at least one of NaCO₃.TeO₂.Pr₆O₁₁, NaYF₄ or YF₃ which is doped with Ho³⁺, Er or Yb, and the up-conversion material has a particle size in a range of 20 nm to 40 nm.

Preferably, the filter membrane includes a red filter membrane, and the light conversion layer disposed on the light entering side of the red filter membrane comprises a quantum dot.

More preferably, the quantum dot is made from CdTe and has a particle size in a range of 2.5 nm to 4.0 nm;

the quantum dot is made from CdSe doped with ZnS and has a particle size in a range of 2.5 nm to 6.3 nm; or

the quantum dot is made from CdSe doped with ZnSe and has a particle size in a range of 2.5 nm to 6.3 nm.

Preferably, the filter membrane includes a green filter membrane, and the light conversion layer disposed on the light entering side of the green filter membrane comprises a quantum dot and/or an up-conversion material.

More preferably, the quantum dot is made from CdTe and has a particle size in a range of 2.5 nm to 4.0 nm, and preferably in a range of 2.5 nm to 3.0 nm;

the quantum dot is made from CdSe doped with ZnS and has a particle size in a range of 2.5 nm to 6.3 nm, and preferably in a range of 2.5 nm to 4.5 nm; or

the quantum dot is made from CdSe doped with ZnSe and has a particle size in a range of 2.5 nm to 6.3 nm, and preferably in a range of 2.5 nm to 4.5 nm; and

the up-conversion material is made from at least one of NaCO₃.TeO₂.Pr₆O₁₁, NaYF₄ or YF₃ which is doped with Ho³⁺, Er or Yb, and the up-conversion material has a particle size in a range of 20 nm to 40 nm.

The present invention further provides a color film substrate including a substrate and various color filter layers which are disposed on the surface of the substrate at different areas, wherein at least a portion of the color filter layers are the color filter layers described herein.

The present invention further provides a display apparatus including the color film substrate described herein.

Since the color film substrates and the display apparatus according to the present invention include color filter membranes comprising light conversion layers, the light of other frequencies in the incident light can be converted into light having the same spectral characteristics as the respective filter membranes, so as to enhance the utilization ratio of light and improve the display brightness, and thus to save energy effectively and improve the display performance.

### BRIEF DESCRIPTION OF THE DRAWINGS

FIG. 1 is a schematic structural diagram of the color filter layer of one embodiment according to the present invention.

FIG. 2 is a schematic structural diagram of a portion of the color film of another embodiment according to the present invention.

Reference numbers as shown in the Figures are listed below:

1—substrate; 2—filter membrane; 3—light conversion layer; and 4—incident light.

### DETAILED DESCRIPTION OF CERTAIN EMBODIMENTS

Embodiments of the present invention will be described in detail with reference to the accompanying figures, so that a person skilled in the art can get a better understanding of the technical solutions of the present invention.

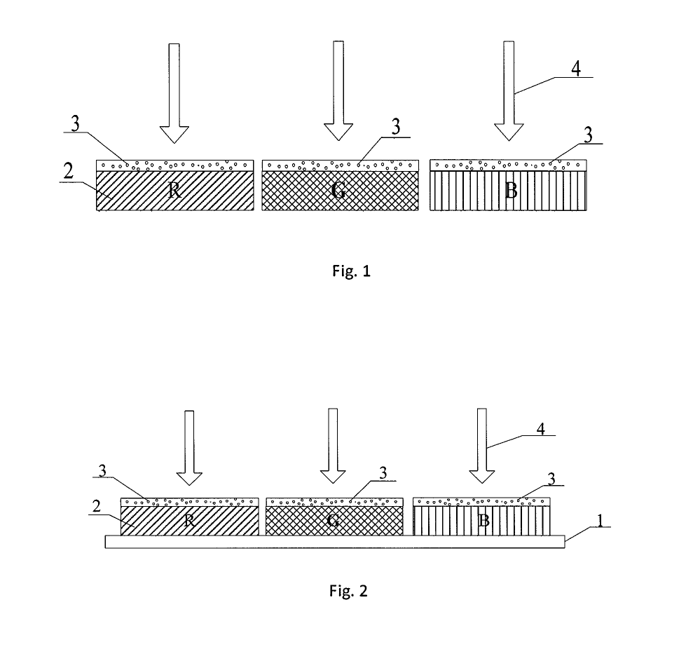

An embodiment according to the present invention provides a color filter layer, as shown in FIG. 1, comprising a filter membrane 2 and a light conversion layer 3 disposed on the light entering side of the filter membrane 2. The light conversion layer 3 is used to convert at least a portion of incident light 4 into light having the same spectral characteristics as the filter membrane 2, so as to improve the utilization ratio of the incident light 4.

The light conversion layer 3 comprises a quantum dot and/or an up-conversion material, and the components of the light conversion layer 3 can be selected according to the spectral characteristics of the filter membrane 2.

Hereafter, the present invention will be illustrated in detail by taking the three typical filter membranes (R, G, and B) as examples, as shown in FIG. 1:

1) Applying an Up-Conversion Material onto the Light Entering Side of a Blue Filter Membrane (B)

The up-conversion material may be made from at least one of NaCO₃.TeO₂.Pr₆O₁₁, NaYF₄ or YF₃ which is doped with Ho³⁺, Er or Yb. The up-conversion material can be prepared by any of the methods known in the art, such as high-temperature solid phase method, hydrothermal synthesis method, sol-gel method, co-precipitation method, etc.

For example, the NaCO₃.TeO₂.Pr₆O₁₁ may be prepared from NaCO₃, TeO₂ and Pr₆O₁₁ by hydrothermal synthesis method.

The NaYF₄ doped with Ho³⁺ may be prepared by a process comprising the steps of dissolving Ho₂O₃ and Y₂O₃ in nitric acid, and then adding ethylenediamine tetraacetic acid (EDTA) as a complexing agent, followed by adding NaF to the resultant system to produce a Ho³⁺ doped NaYF₄ complex.

The rare earth refers to any one of the following 17 elements: La, Ce, Pr, Nd, Pm, Sm, Eu, Gd, Tb, Dy, Ho, Er, Tm, Yb, Lu, Sc and Y. Of course, the compounds of the above mentioned rare earth elements may also be used as substrates being doped. The rare earth-doped up-conversion materials usually are prepared by sol-gel method in which a compound to be doped and an ionic solution of a rare earth element as a dopant are mixed together, and the resulting mixture is stirred and matured at room temperature so as to obtain the desired product.

Those methods for preparation of the up-conversion materials as described above are also suitable to the up-conversion materials used in other color filter layers according to the present invention.

The size of the nanoparticles made from the up-conversion materials is controlled in a range of 20 nm to 40 nm, so as to cause a portion of incident light 4 to convert into light having the same spectral characteristics as the blue filter membrane (B) and thus to improve the utilization ratio of the incident light 4.

A light conversion layer 3 may be prepared by mixing the nanoparticles of any of the up-conversion materials with a transparent binder to form a solution, and then applying the solution onto the light entering side of the blue filter membrane (B) by spray-coating or spin-coating. The binder may be a conventional time-curable, heat-curable, photo-curable, or pressure-curable binder commonly used in the art.

2) Applying Quantum Dots onto the Light Entering Side of a Red Filter Membrane (R)

The quantum dots may be made from at least one of CdTe, CdSe doped with ZnS, and CdSe doped with ZnSe.

The particle size of quantum dots made from CdTe is controlled in a range of 2.5 nm to 4.0 nm; the particle size of quantum dots made from CdSe doped with ZnS is controlled in a range of 2.5 nm to 6.3 nm; and the particle size of quantum dots made from CdSe doped with ZnSe is controlled in a range of 2.5 nm to 6.3 nm. A portion of incident light is converted into light having the same spectral characteristics as the red filter membrane (R) by adjusting the particle size of said quantum dots, such that the utilization ratio of incident light 4 can be improved.

The quantum dots may be prepared by any of the methods known in the art, such as metal-organic synthesis, direct aqueous-phase synthesis, etc. The following preparation methods are illustrated as examples, but the present invention is not restricted thereto.

A method for preparation of CdTe quantum dots includes the steps of: mixing CdCl₂ and an aqueous solution of mercaptoethylamine to form a precursor solution of Cd, adding NaHTe with stirring and adjusting pH to 6, putting the resultant solution into a reactor and heating to initiate reaction, and then cooling the resultant mixture to room temperature so as to obtain CdTe quantum dots.

A method for preparation of CdSe doped with ZnSe includes the steps of: mixing cadmium oxide of a certain amount with stearic acid and heating; adding trioctylphosphine oxide and hexadecylamine, and then injecting Se-solution (Se dissolved in trioctylphosphine oxide) quickly into the mixture to form a solution of CdSe quantum dots; then adding a toluene solution of zinc stearate; and cooling after completion of the reaction to obtain CdSe doped with ZnSe quantum dots by centrifugation.

A method for preparation of CdSe doped with ZnS includes the steps of: preparing a solution of CdSe quantum dots according to the process for preparation of CdSe doped with ZnSe as described above; mixing the aqueous solutions of zinc acetate and sodium sulfide and heating under stirring to form a precursor aqueous solution of Zn and S; adding the precursor aqueous solution of Zn and S slowly into the solution of CdSe quantum dots under Ar₂ atmosphere to initiate reaction under heating and stirring; and then cooling and drying to obtain CdSe doped with ZnS quantum dots.

The resultant CdSe doped with ZnSe or ZnS quantum dots are substantially of core-shell structure, i.e., there is a layer of ZnSe or ZnS on the surface of the CdSe nanoparticle.

Those methods for preparation of quantum dots described above are also suitable to quantum dots used in other color filter layers according to the present invention.

A light conversion layer 3 may be prepared by mixing the quantum dots of any of the above materials with a transparent binder to form a solution, and then applying the solution onto the light entering side of the red filter membrane (R) by spray-coating or spin-coating.

3) Applying Quantum Dots and/or Up-Conversion Material onto the Light Entering Side of a Green Filter Membrane (G)

The quantum dots may be made from at least one of CdTe, CdSe doped with ZnS, and CdSe doped with ZnSe.

The particle size of quantum dots made from CdTe is controlled in a range of 2.5 nm to 4.0 nm, preferably 2.5 nm to 3.0 nm; the particle size of quantum dots made from CdSe doped with ZnS is controlled in a range of 2.5 nm to 6.3 nm, preferably 2.5 nm to 4.5 nm; and the particle size of quantum dots made from CdSe doped with ZnSe is controlled in a range of 2.5 nm to 6.3 nm, preferably 2.5 nm to 4.5 nm. A portion of incident light 4 is converted into light having the same spectral characteristics as the green filter membrane (G) by adjusting the particle size of the quantum dots, such that the utilization ratio of the incident light 4 can be improved.

The up-conversion material may be made from at least one of NaCO₃.TeO₂.Pr₆O₁₁, NaYF₄ or YF₃ which is doped with Ho³⁺, Er or Yb.

The particle size of the nanoparticles made from the up-conversion materials described above is controlled in a range of 20 nm to 40 nm, so as to cause a portion of incident light 4 to convert into light having the same spectral characteristics as the green filter membrane (G) and thus to improve the utilization ratio of the incident light 4.

A light conversion layer 3 may be prepared by mixing the quantum dots and/or the nanoparticles of the up-conversion materials with a transparent binder to form a solution, and then applying the solution onto the light entering side of the green filter membrane (G) by spray-coating or spin-coating.

It is to be understood that, in the case of other types of filter membranes, suitable light conversion materials matching the respective filter membranes can be selected and prepared into a light conversion layer 3 which can cause at least a portion of incident light 4 to convert into light having the same spectral characteristics as the respective filter membranes. All of such technical solutions also fall into the protection scope of the present invention. In addition, the present invention includes the case where only a portion of a filter membrane is provided with a light conversion layer, in other words, the present invention does not require that a light conversion layer is disposed on a whole surface of the filter membrane. The size of the quantum dots or the up-conversion materials can be selected depending on the nature of an incident light source used and the wavelength of light to be converted in practical applications.

Since the preparation methods of the quantum dots and the up-conversion materials are known in the prior art, it is not necessary to describe them in much more detail here.

With the color filter layer according to the present invention, light of other frequencies in the incident light can be converted into light having the same spectral characteristics as the respective filter membranes, due to the presence of a light conversion layer disposed thereon. Therefore, the utilization ratio of light and the display brightness can be improved, and thus energy consumption can be saved effectively and the display performance can be enhanced.

Another embodiment of the present invention provides a color film substrate, as shown in FIG. 2, comprising a substrate 1 and various color filter layers disposed on the surface of the substrate 1 at different areas, wherein each of the color filter layer comprises a filter membrane 2 on the substrate 1 and a light conversion layer 3 disposed on the light entering side of the filter membrane 2. The light conversion layer 3 is used to convert at least a portion of incident light 4 into light having the same spectral characteristics as the filter membrane 2, so as to enhance the utilization ratio of the incident light 4.

The light conversion layer 3 comprises a quantum dot and/or an up-conversion material, and the components of the light conversion layer 3 can be selected according to the spectral characteristics of the filter membrane 2.

Hereafter, the color film substrate according to the present invention will be illustrated in detail by taking the three typical filter membranes (R, G, and B) as examples, as shown in FIG. 2:

1) Applying an Up-Conversion Material onto the Light Entering Side of a Blue Filter Membrane (B)

The up-conversion material may be made from at least one of NaCO₃.TeO₂.Pr₆O₁₁, NaYF₄ or YF₃ which is doped with Ho³⁺, Er or Yb.

The NaCO₃.TeO₂.Pr₆O₁₁ may be prepared from NaCO₃, TeO₂ and Pr₆O₁₁ by hydrothermal synthesis method.

The NaYF₄ doped with Ho³⁺ may be prepared by a process comprising the steps of dissolving Ho₂O₃ and Y₂O₃ in nitric acid, and then adding ethylenediamine tetraacetic acid (EDTA) as a complexing agent, followed by adding NaF to the resultant system to produce a Ho³⁺ doped NaYF₄ complex.

The rare earth refers to any one of the following 17 elements: La, Ce, Pr, Nd, Pm, Sm, Eu, Gd, Tb, Dy, Ho, Er, Tm, Yb, Lu, Sc and Y. Of course, the compounds of the above mentioned rare earth elements may also be used as substrates being doped.

The size of the nanoparticles made from the up-conversion materials is controlled in a range of 20 nm to 40 nm, so as to cause a portion of incident light 4 to convert into light having the same spectral characteristics as the blue filter membrane (B) and thus to improve the utilization ratio of the incident light 4.

A light conversion layer 3 may be prepared by mixing the nanoparticles of the up-conversion materials with a transparent binder to form a solution, and then applying the solution onto the light entering side of the blue filter membrane (B) by spray-coating or spin-coating. The binder may be a conventional time-curable, heat-curable, photo-curable, or pressure-curable binder commonly used in the art.

2) Applying Quantum Dots onto the Light Entering Side of a Red Filter Membrane (R)

The quantum dots may be made from at least one of CdTe, CdSe doped with ZnS, and CdSe doped with ZnSe.

The particle size of quantum dots made from CdTe is controlled in a range of 2.5 nm to 4.0 nm; the particle size of quantum dots made from CdSe doped with ZnS is controlled in a range of 2.5 nm to 6.3 nm; and the particle size of quantum dots made from CdSe doped with ZnSe is controlled in a range of 2.5 nm to 6.3 nm. A portion of incident light 4 is converted into light having the same spectral characteristics as the red filter membrane (R) by adjusting the particle size of the quantum dots, such that the utilization ratio of the incident light 4 can be improved.

A light conversion layer 3 may be prepared by mixing the quantum dots of any of the above materials with a transparent binder to form a solution, and then applying the solution onto the light entering side of the red filter membrane (R) by spray-coating or spin-coating.

3) Applying Quantum Dots and/or Up-Conversion Material onto the Light Entering Side of a Green Filter Membrane (G)

The quantum dots may be made from at least one of CdTe, CdSe doped with ZnS, and CdSe doped with ZnSe.

The particle size of quantum dots made from CdTe is controlled in a range of 2.5 nm to 4.0 nm, preferably 2.5 nm to 3.0 nm; the particle size of quantum dots made from CdSe doped with ZnS is controlled in a range of 2.5 nm to 6.3 nm, preferably 2.5 nm to 4.5 nm; and the particle size of quantum dots made from CdSe doped with ZnSe is controlled in a range of 2.5 nm to 6.3 nm, preferably 2.5 nm to 4.5 nm. A portion of incident light 4 is converted into light having the same spectral characteristics as the green filter membrane (G) by adjusting the particle size of the quantum dots, such that the utilization ratio of the incident light 4 can be improved.

The up-conversion material may be made from at least one of NaCO₃.TeO₂.Pr₆O₁₁, NaYF₄ or YF₃ which is doped with Ho³⁺, Er or Yb.

The size of the nanoparticles made from any of the above up-conversion materials is controlled in a range of 20 nm to 40 nm, so as to cause a portion of incident light 4 to convert into light having the same spectral characteristics as the green filter membrane (G) and thus to improve the utilization ratio of the incident light 4.

A light conversion layer 3 may be prepared by mixing the quantum dots and/or the nanoparticles of the up-conversion materials with a transparent binder to form a solution, and then applying the solution onto the light entering side of the green filter membrane (G) by spray-coating or spin-coating.

It is to be understood that, in the case of other types of filter membranes, suitable light conversion materials matching the respective filter membranes can be selected and prepared into a light conversion layer 3 which can cause at least a portion of incident light 4 to convert into light having the same spectral characteristics as the respective filter membranes. All of such technical solutions also fall into the protection scope of the present invention. In addition, the present invention includes the case where only a portion of a filter membrane is provided with a light conversion layer, in other words, the present invention does not require that a light conversion layer is disposed on a whole surface of the filter membrane. The size of the quantum dots or the up-conversion materials can be selected depending on the nature of an incident light source used and the wavelength of light to be converted in practical applications.

Since the preparation methods of the quantum dots and the up-conversion materials are known in the prior art as described above, it is not necessary to describe them in much more detail here.

Yet another embodiment of the present invention provides a display apparatus comprising the color film substrate according to the present invention. The display apparatus may be a liquid crystal display (LCD) apparatus. For example, the LCD apparatus is mainly composed of a backlight source, an LCD screen (panel), structural components (such as frame, backplane, etc.), a driving circuit and so on.

Obviously, the display apparatus may also be a display apparatus of other types, such as an OLED display apparatus.

The color film substrate of the display apparatus according to the present invention comprises a light conversion layer, such that the light of other frequencies in the incident light can be converted into light having the same spectral characteristics as the respective filter membranes, so as to enhance the utilization ratio of light and improve the display brightness, and thus to save energy effectively and improve the display performance.

### EXAMPLES

### Examples 1-6

The color filter layers and color film substrates of Examples 1-6 were prepared by the process described below, using the filter membranes and light conversion materials listed in Table 1. Firstly, a black matrix (BM) layer was prepared on a glass, and R, G, or B filter membrane layer was disposed separately according to the requirement of the respective examples. Then, the respective quantum dots or up-conversion materials were sprayed onto the light entering side of the corresponding R, G, or B filter membrane at substantially one-particle thickness by a filter membrane repairing device (Jupite 7392-θWSTLT3RVR-HG, V-Technology Company), so as to form a color filter layer. Finally, an overcoat (OC) layer was coated on the resultant color filter layer, followed by forming a photospacer (PS) layer, and thus a color film substrate was finished. The quantum dots and up-conversion materials were prepared by the methods described above.

The performances of the color filter layers and display devices prepared by Examples 1-6 were tested by a procedure as follows: the light transmittance of the respective color film substrates was measured by a spectrophotometer (AP41-0125, Otsuka Co. Ltd), and the result was compared with that of a color film substrate without any quantum dot and up-conversion material. A higher transmittance indicates that the color film substrate has a higher utilization ratio of light, and therefore the display apparatus comprising the same exhibits a higher brightness.

The components and the test results of the color filter layers prepared in Examples (Ex.) 1-6 are shown in Table 1 below.

### Comparative Example 1-3

The color filter layers and color film substrates of Comparative Examples (CE) 1-3 were the same as those of Examples 1-6, except that no light conversion material was applied to the respective filter membranes (B, G, R). The performances thereof were tested according to the same procedure as described above, and the results are shown in Table 1 below.

TABLE 1

| | | Light conversion material | | |
|---|---|---|---|---|
| | Filter | Up-conversion material/ | Quantum dot/ | Relative |
| | membrane | binder | binder | transmittance |
| Ex. 1 | B | NaCO₃•TeO₂•Pr₆O₁₁ | | 120% |
| | | (20-40 nm)/terpilenol | | |
| Ex. 2 | B | NaYF₄ doped with Ho³⁺ | | 120% |
| | | (20-40 nm)/ | | |
| | | terpilenol | | |
| Ex. 3 | R | | CdTe (2.5-4 nm)/ | 150% |
| | | | terpilenol | |
| Ex. 4 | R | | CdSe doped with ZnS | 150% |
| | | | (2.5-6.3 nm)/ | |
| | | | terpilenol | |
| Ex. 5 | G | | CdTe (2.5-3 nm)/ | 125% |
| | | | terpilenol | |
| Ex. 6 | G | NaYF₄ doped with | | 115% |
| | | Ho³⁺(20 nm)/ | | |
| | | terpilenol | | |
| CE 1 | B | | | 100% |
| CE 2 | R | | | 100% |
| CE 3 | G | | | 100% |

Note:
all the filter membranes were obtained from BOE, and all the reagents and binder (terpilenol) were obtained from Sinopharm Chemical Reagent Co. Ltd. The up-conversion materials or quantum dots were mixed with the binder at a ratio of 1 g:100 ml, respectively. The mole ratio of Ho³⁺ in the up-conversion material, NaYF₄ doped with Ho³⁺, is less than 0.7%. The CdSe doped with ZnS has a core-shell structure, i.e., there is a layer of ZnS on the surface of the CdSe nanoparticle, wherein the ratio of Cd:Zn is about 1:1.9 (element ratio).

From the test results shown in Table 1, it can be seen that each of the color filter layers comprising a light conversion layer of the present invention has a light utilization ratio significantly higher than the respective Comparative Examples, which demonstrates that the presence of a light conversion layer is indeed useful to improve the light utilization ratio and the display brightness, and thus to save energy effectively and enhance the display performance.

It is understood that the present invention is not limited to the above-illustrated embodiments, which were chosen and described in order to best explain the principles of the invention. Those skilled in the art can make various modifications or variations without departing from the spirit and essence of the present invention. It is intended that the scope of the invention be defined by the following claims and their equivalents.

1-11. (canceled)

12. A color filter layer, characterized by comprising a filter membrane and a light conversion layer disposed on the light entering side of the filter membrane.

13. The color filter layer of claim 12, characterized in that the light conversion layer comprises a quantum dot and/or an up-conversion material.

14. The color filter layer of claim 13, characterized in that the quantum dot is made from at least one of CdTe, CdSe doped with ZnS, and CdSe doped with ZnS.

15. The color filter layer of claim 12, characterized in that the filter membrane includes a blue filter membrane, and the light conversion layer disposed on the light entering side of the blue filter membrane comprises an up-conversion material.

16. The color filter layer of claim 15, characterized in that the up-conversion material is made from at least one of NaCO₃.TeO₂.Pr₆O₁₁, NaYF₄ or YF₃ which is doped with Ho³⁺, Er or Yb, and the up-conversion material has a size in a range of 20-40 nm.

17. The color filter layer of claim 12, characterized in that the filter membrane includes a red filter membrane, and the light conversion layer disposed on the light entering side of the red filter membrane comprises a quantum dot.

18. The color filter layer of claim 13, characterized in that the filter membrane includes a red filter membrane, and the light conversion layer disposed on the light entering side of the red filter membrane comprises a quantum dot.

19. The color filter layer of claim 14, characterized in that the filter membrane includes a red filter membrane, and the light conversion layer disposed on the light entering side of the red filter membrane comprises a quantum dot.

20. The color filter layer of claim 17, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm.

21. The color filter layer of claim 18, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm.

22. The color filter layer of claim 19, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm.

23. The color filter layer of claim 12, characterized in that the filter membrane includes a green filter membrane, and the light conversion layer disposed on the light entering side of the green filter membrane comprises a quantum dot and/or an up-conversion material.

24. The color filter layer of claim 13, characterized in that the filter membrane includes a green filter membrane, and the light conversion layer disposed on the light entering side of the green filter membrane comprises a quantum dot and/or an up-conversion material.

25. The color filter layer of claim 14, characterized in that the filter membrane includes a green filter membrane, and the light conversion layer disposed on the light entering side of the green filter membrane comprises a quantum dot and/or an up-conversion material.

26. The color filter layer of claim 23, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm; and
the up-conversion material is made from at least one of NaCO₃.TeO₂.Pr₆O₁₁, NaYF₄ or YF₃ which is doped with Ho³⁺, Er or Yb, and the up-conversion material has a particle size in a range of 20 nm to 40 nm.

27. The color filter layer of claim 24, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm; and
the up-conversion material is made from at least one of NaCO₃.TeO₂.Pr₆O₁₁, NaYF₄ or YF₃ which is doped with Ho³⁺, Er or Yb, and the up-conversion material has a particle size in a range of 20 nm to 40 nm.

28. The color filter layer of claim 25, characterized in that the quantum dot is made from CdTe and has a particle size in a range of 2.5 nm to 4.0 nm;
the quantum dot is made from CdSe doped with ZnS and has a particle size in a range of 2.5 nm to 6.3 nm; or
the quantum dot is made from CdSe doped with ZnSe and has a particle size in a range of 2.5 nm to 6.3 nm; and
the up-conversion material is made from at least one of NaCO₃.TeO₂.Pr₆O₁₁, NaYF₄ or YF₃ which is doped with Ho³⁺, Er or Yb, and the up-conversion material has a particle size in a range of 20 nm to 40 nm.

29. A color film substrate, characterized by including a substrate and various color filter layers disposed on a surface of the substrate at different areas, wherein at least a portion of the color filter layers is a color filter layer comprising a filter membrane and a light conversion layer disposed on the light entering side of the filter membrane.

30. A display apparatus, characterized by comprising a color film substrate including a substrate and various color filter layers disposed on a surface of the substrate at different areas, wherein at least a portion of the color filter layers is a color filter layer comprising a filter membrane and a light conversion layer disposed on the light entering side of the filter membrane.
